(19) United States
(12) Patent Application Publication
(10) Pub. No.: US 2022/0373980 A1
(43) Pub. Date: Nov. 24, 2022

(54) DYMAMIC CONTROL OF A MANUFACTURING PROCESS USING DEEP REINFORCEMENT LEARNING

(71) Applicant: Massachusetts Institute of Technology, Cambridge, MA (US)

(72) Inventors: Brian W. ANTHONY, Cambridge, MA (US); Donghyun KIM, Cambridge, MA (US); Sangwoon KIM, Cambridge, MA (US)

(73) Assignee: Massachusetts Institute of Technology, Cambridge, MA (US)

(21) Appl. No.: 17/662,145

(22) Filed: May 5, 2022

Related U.S. Application Data
(60) Provisional application No. 63/185,063, filed on May 6, 2021.
(60) Provisional application No. 63/210,740, filed on Jun. 15, 2021.

(51) Int. Cl. G05B 13/02; G06K 9/62

(52) U.S. Cl. CPC G05B 13/027; G06K 9/6256

(57) ABSTRACT

Described is a model-free deep reinforcement learning (DRL) control system and technique. In embodiments, the DRL control system and technique may be used in a real-time manufacturing process. In embodiments, a DRL control system and technique may be used for controlling a fiber drawing system. The DRL-based control system predictively regulates a fiber diameter to track dynamically varying reference trajectories.

### CROSS-REFERENCE TO RELATED APPLICATIONS

This application claims the benefit of U.S. Provisional Application No. 63/185,063, filed on May 6, 2021 and this application also claims the benefit of U.S. Provisional Application No. 63/210,740, filed on Jun. 15, 2021 under 35 U.S.C. § 119(e) which applications are hereby incorporated herein by reference in their entireties.

### BACKGROUND

Control systems and techniques used in manufacturing systems and processes are desirable to control one or more characteristics of a manufacturing process and/or of an item being manufactured (i.e., an article of manufacture).

Such control systems and processes control physical characteristics of an article of manufacture produced by the manufacturing system and process. Such control systems, however, require mathematical and numerical models (or more simply, models) of the particular manufacturing system and process being controlled.

It would, therefore, be desirable to provide a control system and technique for use in manufacturing systems and processes which is not dependent upon [a priori] accurate modeling of a specific manufacturing system and process. It would be desirable to provide a control system which learns, and enables the manufacture of articles having varying characteristics. For example, it would be desirable to provide a manufacturing system and process having a control system capable of capable of supporting varying geometries, new materials, and fabrication methodologies for an article of manufacture.

### SUMMARY

In accordance with the concepts, systems and techniques described herein, it has been recognized that a control system based upon a dynamic model provides a control system which is not dependent upon accurate numerical modeling of a specific manufacturing system and process.

In accordance with the concepts, systems and techniques described herein, it has been found that a subset of machine learning (ML) referred to as deep reinforcement learning (DRL) may be used to teach (or train) a controller about all of one or more characteristics of the materials, machines, and processes used to manufacture an article and to track a dynamically varying reference trajectory of one or more characteristics of the article of manufacture. Thus, described herein are concepts, systems and techniques for utilizing DRL systems and techniques whereby the controller learns better and better models and then controls a manufacturing process with improved performance. A control system provided in accordance with this concept may be referred to as a dynamic model control system.

Such a dynamic model control system enables the manufacture of articles having varying characteristics. For example, such a dynamic model control system enables a single manufacture system to: manufacture articles having dynamically varying physical geometries; manufacture articles using different materials; and manufacture articles using a variety of different fabrication methodologies. Thus, a control system provided in accordance with the techniques described herein can learn a model of the system it is controlling and use that learning to improve the controller's performance over time, and to self-optimize the controlled process at multiple and varying setpoints of operation.

Such a DRL-based control system does not require a starting analytical or numerical model (i.e. the DRL-based control system does not require prior analytical or numerical models of the manufacturing system or process) and can predictively regulate various types characteristics of an article of manufacture and track varying reference trajectories. Furthermore, such a DRL control system can be implemented in real-time manufacturing systems and processes. In one aspect, a DRL-based control system may be utilized with a manufacturing system and process having stochastic behavior and non-linear delayed dynamics.

Furthermore, such a DRL-based control system provided in accordance with the concepts described herein outperforms both proportional-integral-derivative (PID) control systems and model predictive control (MPC) systems in terms of tracking performance (i.e., the ability to track variations of a characteristic of an article of manufacture being produced).

In accordance with another aspect of the concepts, systems and techniques described herein, it has been recognized that in a fiber drawing system and process a dynamic model for the transition between different set points is required to control fiber diameter during a fiber drawing process. It has also been recognized that DRL may be used to teach (or train) a controller in a fiber drawing control system over all possible diameter setpoints and to track a dynamically varying reference trajectory of diameter. Thus, also described herein are concepts, systems and techniques for utilizing DRL systems and techniques to learn and then control a fiber drawing process.

Such a DRL-based fiber drawing control system does not require an analytical or numerical model, can predictively track various types of reference trajectories and can be implemented in real-time manufacturing processes.

Such a DRL-based fiber drawing control system provided in accordance with the concepts described herein outperforms both proportional-integral-derivative (PID) control systems and model predictive control (MPC) systems in terms of tracking performance.

Such a DRL-based fiber drawing control system may be used to provide a compact fiber drawing system.

While typical fiber drawing towers may be about several meters high, such a compact fiber drawing system as described herein is a compact (or miniaturized) version of those towers. In embodiments, the towers may be on the order of about 50 centimeters (cm) high. Such a compact fiber drawing system comprises: an extruder system for heating and feeding a preform into the system; a micrometer (e.g. a laser micrometer) configured to measure a fiber diameter after the fiber is drawn from the extruder; and a cooling system and spool system to cool and store the produced fiber. Such a compact fiber drawing system takes several control inputs and measures several outputs. As the control inputs, the compact fiber drawing system takes: spool voltage, preform feedrate, and etc. As the measured output, the compact fiber drawing system measures: diameter, spool speed, and etc. Based upon these inputs and outputs, the dynamic model controller provided in accordance with the concepts described herein regulates the fiber diameter and tension.

In one aspect, a DRL-based control system may be utilized with a fiber drawing system and process with stochastic behavior and non-linear delayed dynamics. The DRL-based control system predictively regulates a diameter of a fiber to track dynamically varying reference trajectories. And significantly, the DRL-based control system does not require prior analytical or numerical models of the fiber drawing system.

In embodiments, the DRL framework described herein may be applied to a fiber drawing system including, but not limited to a small scale fiber drawing system.

In one aspect of the concepts described herein, a model-free deep reinforcement learning (DRL) control system and technique for controlling a fiber drawing system comprises means for predictively regulating a fiber diameter to track dynamically varying reference trajectories. In one embodiment, the DRL-based fiber drawing control system is trained and implemented on a small scale fiber drawing system, which exhibits stochastic behavior and non-linear delayed dynamics.

In one fiber drawing control system embodiment, for a reference trajectory with random step changes, after one (1) hour of training a DRL-based fiber drawing control system provided in accordance with the concepts described herein, showed the same root mean squared error (RMSE) as a proportional integral (PI) controller and after three (3) hours of training the DRL-based fiber drawing control system achieved the performance of quadratic dynamic matrix controller (QDMC). The DRL controller showed less than one (1) second of time lag in a step response (compared with 5.7 seconds of time lag in a PI feedback controller with the same step response). Controller performance on trajectories not used in the training process were also conducted. For a sinusoidal sweep reference trajectory, the DRL-based fiber drawing control system maintained the RMSE under 40 um to a frequency of 45 mHz, compared to 25 mHz for a QDMC.

In one aspect of the concepts sought to be protected, described is a compact fiber drawing system implemented using a DRL-based control system and technique. In embodiments, the DRL-based control system and technique regulates fiber diameter to track time-varying reference trajectories. By customizing DRL algorithms, performance of control (in terms of tracking error) in a fiber drawing process may be increased. Without analytical or numerical models of the physical system, the DRL-based control system is configured to learn to track various types of reference trajectories under stochasticity and non-linear delayed dynamics of a fiber drawing system. The DRL-based control system is configured to generalize to track a reference that it had not experienced during a training process. In embodiments, the DRL-based control system may include a pretraining process during which the DRL-based control system learns from pre-existing production data to thereby decrease the amount of time required for online training of the control system.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a block diagram of a manufacture system coupled to a deep reinforcement learning (DRL) control system;

FIG. 2A is an isometric view of a small-scale fiber drawing system;

FIG. 2B is an enlarged isometric view of an extruder system portion of the fiber drawing system of FIG. 2A;

FIG. 2C is an enlarged isometric view of a spool system portion of the fiber drawing system of FIG. 2A;

FIG. 3 is a block diagram of a fiber drawing system coupled to a DRL control system;

FIG. 4A is a block diagram of inputs, outputs and network structures of an actor component (or more simply, “an actor”) and a critic component (or more simply, “a critic”) which may be used in a DRL control system which may be the same as or similar to the DRL control systems of FIGS. 1 and 3;

FIG. 4B is a block diagram of inputs, outputs and network structures of an actor and a critic which may be used in a DRL control system which may be the same as or similar to the DRL control systems of FIGS. 1 and 3;

FIG. 5A is a plot of spool speed vs. duty cycle for a fiber drawing system which may be the same as or similar to the fiber drawing system of FIG. 3;

FIG. 5B is a plot of spool speed vs. input for a fiber drawing system which may be the same as or similar to the fiber drawing system of FIG. 3;

FIG. 6A is plot of diameter vs. time for a fiber drawing system which may be the same as or similar to the fiber drawing system of FIG. 3;

FIG. 6B is plot of DRL controller's input actions for each reference trajectory vs. time for a fiber drawing system which may be the same as or similar to the fiber drawing system of FIG. 3;

FIG. 6C is plot of target diameter, measured diameter, root mean squared error (RMSE) and DRL controller's input actions for each reference trajectory vs. time for a fiber drawing system which may be the same as or similar to the fiber drawing system of FIG. 3;

FIG. 6D is plot of fiber diameter and DRL controller input actions for each reference trajectory vs. time for a fiber drawing system which may be the same as or similar to the fiber drawing system of FIG. 3;

FIG. 6E is plot of diameter vs. time for a fiber drawing system which may be the same as or similar to the fiber drawing system of FIG. 3;

FIG. 6F is plot of root mean squared error (RMSE) vs. time for a fiber drawing system which may be the same as or similar to the fiber drawing system of FIG. 3;

FIG. 6G is plot of DRL controller input actions for each reference trajectory vs. time for a fiber drawing system which may be the same as or similar to the fiber drawing system of FIG. 3;

FIG. 6H is plot of optical fiber diameter vs. time for a fiber drawing system which may be the same as or similar to the fiber drawing system of FIG. 3;

FIG. 6I is plot of DRL controller input action vs. time for a fiber drawing system which may be the same as or similar to the fiber drawing system of FIG. 3;

FIG. 7A is plot of root mean squared error (RMSE) vs. time for a fiber drawing system which may be the same as or similar to the fiber drawing system of FIG. 3;

FIG. 7B is plot of root mean squared error (RMSE) vs. time for a fiber drawing system which may be the same as or similar to the fiber drawing system of FIG. 3;

FIG. 7C is plot of root mean squared error (RMSE) vs. time for a fiber drawing system which may be the same as or similar to the fiber drawing system of FIG. 3;

FIG. 8A is a plot of optical fiber diameter vs. time for a fiber drawing system which may be the same as or similar to the fiber drawing system of FIG. 3;

FIG. 8B is a plot of input action with linearization vs. time for a fiber drawing system which may be the same as or similar to the fiber drawing system of FIG. 3;

FIG. 8C is a plot of input action without linearization vs. time for a fiber drawing system which may be the same as or similar to the fiber drawing system of FIG. 3;

FIG. 8D is a plot of optical fiber diameter tracking and input action comparison for a fiber drawing system which may be the same as or similar to the fiber drawing system of FIG. 3;

FIG. 8E is a plot of input action with linearization vs. time for a fiber drawing system which may be the same as or similar to the fiber drawing system of FIG. 3;

FIG. 8F is a plot of input action without linearization vs. time for a fiber drawing system which may be the same as or similar to the fiber drawing system of FIG. 3;

FIG. 8G is a plot of diameter tracking and input action comparison for a fiber drawing system which may be the same as or similar to the fiber drawing system of FIG. 3;

FIG. 8H is a plot of input action with linearization vs. time for a fiber drawing system which may be the same as or similar to the fiber drawing system of FIG. 3; and

FIG. 8I is a plot of input action without linearization vs. time.

### DETAILED DESCRIPTION

Described are concepts related to a process control system which may be used in a wide variety of different application.

Before describing the broad concepts sought to be protected herein some introductory information is provided.

Reinforcement learning (RL) is a programming method that trains an algorithm by maximizing rewards or minimizing penalties. An RL agent interacts with its surrounding environment over time. The RL agent receives observation and reward from the environment and in response thereto computes an action based upon its policy. The environment is affected by the action and the new reward that corresponds to the new state of the environment is computed. The cycle is repeated until the task is finished. In this cycle, the action that resulted in high reward is said to be “reinforced.” The agent learns to prefer the action that is similar to the reinforced action. As a result, the agent is optimized to maximize the expected future reward. In manufacturing processes, a controller and a manufacturing process are considered as the agent and the environment; the controller receives the observations through sensor readings and computes the input actions.

The concepts, systems and techniques described are related to control systems. In accordance with the systems concepts, systems and techniques described, it has been found that a subset of machine learning (ML) referred to as deep reinforcement learning (DRL) may be used to teach (or train) a controller over all of one or more characteristics of an article of manufacture and to track a dynamically varying reference trajectory of one or more characteristics of the article of manufacture. Thus, described herein are concepts, systems and techniques for utilizing DRL systems and techniques to learn and then control a manufacturing system and/or associated manufacturing process.

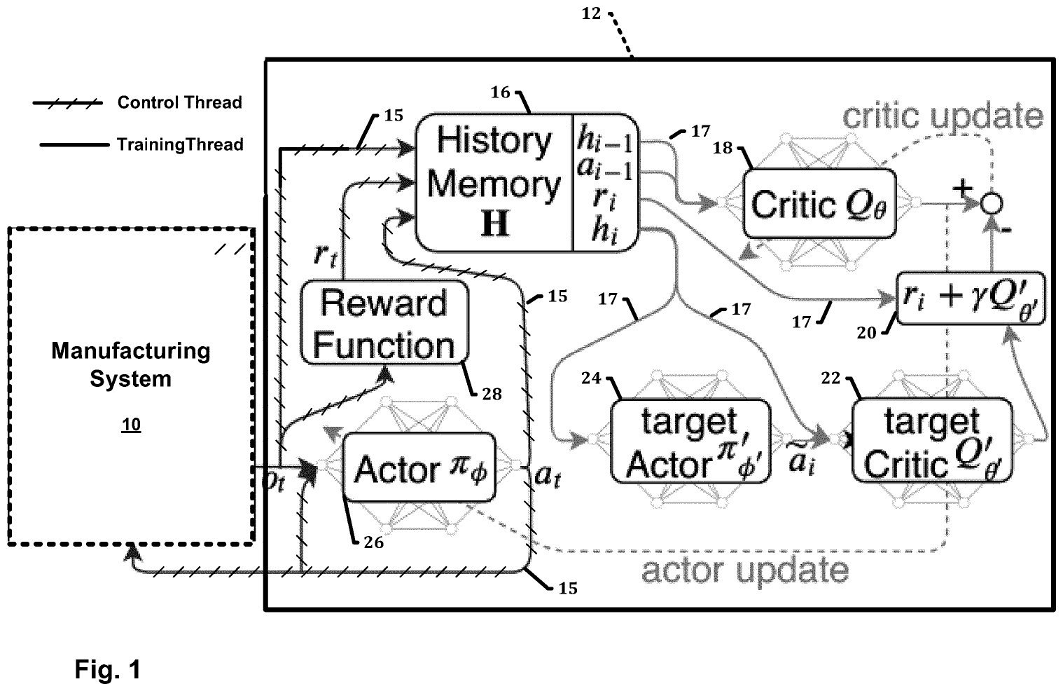

As illustrated in FIG. 1, the DRL control system described herein utilizes an Actor-Critic approach. This approach separates the actor and the critic, each representing the agent (controller) and the Q-function. In general overview, an actor component (or more simply, “an actor”) acts as the agent observing a state from the environment and computing actions accordingly. A critic component (or more simply, “a critic”) evaluates the actor's action by estimating Q-values (state-action values). A critic takes the observations and the actions as the inputs and computes the Q-value estimation. Based upon the critic's evaluation, the actor is updated along the direction that increases the Q-value estimation. Simultaneously or concurrently, the critic is also updated by reducing (and ideally, minimizing) the TD error in the Bellman equation. Consequently, the critic converges near the true Q-value and the actor is optimized to maximize the Q-value.

In deep reinforcement learning (DRL), multilayer perceptrons are often used as function approximators for the actor and the critic (e.g., a deep deterministic policy gradient (DDPG)). Recurrent Neural Networks (RNN) may be used to consider the history of the observations and actions (e.g., recurrent deterministic policy gradient (RDPG)). There are some cases where multiple critics are used (e.g., twin delayed DDPG (TD3)).

Full observability means an observation can represent a current state completely. Therefore, if a state is fully observed, the probability distribution of the next state only depends upon a current observation and a current action. This type of model is a Markov decision process (MDP). On the other hand, partial observability means an observation can represent only partial components of the full state. Therefore, the probability distribution of the next state cannot be determined based on the current observation and the current action. This model is a partially observed Markov decision process (POMDP).

In the fiber drawing process discussed below as one example of a system which may benefit from a DRL control system operating in accordance with the concepts described herein, sensors measure a diameter of a fiber, a temperature of a heating chamber, speed of a spool motor, and a feed-rate of an extruder. It should, however, be appreciated this is not a full system observation mainly due to delayed dynamics and unobserved parameters such as the tension. The diameter response to the feed-rate or the spool-speed change is delayed by the few seconds it takes for material to flow through the system. Therefore, the history of observations and actions are needed to predict the future states accurately. One solution to this problem is using RNN. RNNs pass activation values to consecutive timestep so the inputs at the previous timesteps are considered when computing outputs.

Conversely, a non-recurrent network fully re-computes its outputs at each timestep using only the current input.

A neural network is generally updated along a gradient direction. In a typical feed-forward network, the gradient is backpropagated from the output layer to the input layer. In RNNs, the gradient is also backpropagated through time (BPTT) to consider the previous inputs while updating. LSTM is a type of RNN that enables BPTT to reach farther timesteps, preventing the gradient from vanishing by using a gate mechanism. Therefore, LSTM finds use in a wide variety of applications and domains such as robot manipulation, self-driving cars and language modeling.

To promote clarity in the description of the concepts sought to be protected, reference is sometimes made herein to a fiber drawing system and process and an associated article of manufacture (i.e., an optical fiber). Such a fiber drawing system and process are intended as only one example of a manufacturing system and/or associated manufacturing process which may utilize the concepts described herein. It should thus be appreciated and understood references to a fiber drawing system are not intended to be and should not be construed as limiting of the described concepts systems and techniques.

For example, a DRL control system provided in accordance with the concepts described herein may find use in the manufacture of coffer (e.g., to control coffee aroma and/or color via control of coffee roasting temperatures by controlling a trajectory of a temperature to which coffee beans are exposed during a roasting (or baking) process.

As another example, a DRL control system provided in accordance with the concepts described herein may find use in a process for forming rolled tubes out of flat card stock. In this example, a DRL control system functions to achieve a certain/desired repetitive process for rolling of flat card stock into a tube-shape (e.g. continuously rolling flat sheets into a tube-shaped article of manufacture).

In short, the DRL control system and concepts described herein may find use in any manufacturing processes which requires control.

Turning now to FIG. 1, a control system 12 is coupled to a manufacturing system 10 (here shown in phantom since system 10 is not properly a part of the control system. Manufacturing system 10 may be or may comprise, for example, an apparatus, machine or device. Control system 12 is based upon a dynamic model (i.e., a model which may be updated as system 10 is operating—i.e., the model is updated on-the-fly or dynamically). As will be described in detail below, by providing control system 12 as a dynamical system, control system 12 is not dependent upon accurate modeling of a specific manufacturing system nor a specific manufacturing process.

Thus, while conventional control systems would require an accurate model of system 10, a control system provided in accordance with the concepts described herein does not require an accurate model of the system being controlled.

Briefly, deep reinforcement learning (DRL) may be used to teach (or train) control system 12 over all of one or more characteristics of an article of manufacture provided by system 10 and/or one characteristics of a system (e.g., system 10) which produces the article of manufacture. DRL may also be used to teach (or train) controller 12 to track a dynamically varying reference trajectory of the one or more characteristics of the article of manufacture and/or a system which produces the article of manufacture. Thus, control system 12 utilizes DRL systems and techniques to learn and then control a process (e.g., a manufacturing process) of manufacturing system 10 such that system 10 is able to provide one or more article of manufacture having one or more desired characteristics. Control system 12 may thus sometimes be referred to herein as a DRL controller or a dynamic model control system (or more simply a “dynamic model controller”).

Dynamic model controller 12 enables the manufacture of articles having varying characteristics. For example, dynamic model controller enables manufacture apparatus such as system 10 to: manufacture articles having varying physical geometries; manufacture articles using different materials; and manufacture articles using a variety of different fabrication or manufacture methodologies.

Significantly, a DRL-based controller such as control system 12 does not require an analytical or numerical model (i.e., the DRL-based control system does not require prior analytical or numerical models of the manufacturing system or process) and can predictively regulate various types of characteristics of an article of manufacture and can track varying reference trajectories. Furthermore, DRL controller 12 can be implemented in real-time manufacturing systems and processes (i.e., manufacturing system 10 may be a real-time manufacturing system and process controlled by DRL controller 12). Further still, DRL controller 12 may be utilized with a manufacturing system and process having stochastic behavior and non-linear delayed dynamics (i.e., manufacturing system 10 and the associated manufacturing process may have stochastic behavior and non-linear delayed dynamics).

Furthermore, a DRL-based control system provided in accordance with the concepts described herein outperforms both proportional-integral-derivative (PID) control systems and model predictive control (MPC) systems in terms of tracking performance (i.e., the ability to track variations of a characteristic of an article of manufacture being produced).

Control sytem 12 includes a control thread identified by reference numeral 15 in FIG. 1 and a train thread (also sometimes referred to herein as a learning thread) identified by reference numeral 17 in FIG. 1. In general overview, at a high level, control thread 15 performs a function/process which may, at least in some respects, be the same as or similar to the functions performed by a conventional real-time controller.

However, in accordance with the concepts described herein, control thread 15 of a DRL controller provides active control (e.g., at a milli-second time resolution) of the system 10. That is, control thread 15 may provide active control of one or more subsystems which comprise system 10. In this way, control thread 15 improves performance of machine subsystems (e.g., correcting errors in one or more portion of system 10) and thereby improves performance of the system being controlled (e.g., system 10). This result is achieved by integrating control thread 15 with a training thread 17 of the DRL control system. For reasons which will become apparent from the description hereinbelow, training thread 17 is sometimes referred to herein as learning thread 17.

Control thread 15 of DRL control system 12 comprises an actor 26. Given, a particular system response, the actor 26 determines (via an existing model) what control signals (e.g., voltage signals, current signals, etc. . . . ) to apply to system 10. Thus, actor 26 is sometime referred to herein as controller 26.

Training thread 17 operates to continuously learn from both the control effort (i.e., the amount of control actually occurring) and data being received by control system 12 from the system being controlled. The control effort may be, for example, the number and significance of changes occurring in subsystems, machines or devices which make up system 10. Such subsystems or devices may correspond to mechanical systems. The data being received by control system 12 may correspond, for example, to data sampled, measured or otherwise gathered from various portions of system 10 such as data from one of more subsystems which make up system 10. Such data may be collected, for example, via one or more sensors coupled to various portions of system 10. With this information/data, training thread 17 operates to update/improve controller operation (i.e., update/improve the function/performance of the controller (or control thread) such that that system/subsystem being controlled performs in a desired manner (and ideally, an optimized manner).

History memory 16 receives data from system 10. Thus, memory 16 has both current and past data stored therein. Past data may include, for example, measurements made over period of time (e.g., with the last several minutes or more) of operation of manufacturing system 10 as well as data/information representing a control effort of the machine being controlled (i.e., the control effort of the manufacturing system 10). Thus, memory 16 may be considered as storing a running log of the history of the manufacturing system being controlled.

The particular amount of data stored in memory 16 and the time period over which such data occurred depends upon a variety of factors including, but not limited to, a rate at which data is sampled, the size of memory 16, and the complexity of the system being controlled (e.g., the complexity of manufacturing system 10). The amount of data measured is related to the complexity of the system. Furthermore, the rate at which data is sampled may be related to characteristics of the system/machine being controlled and/or the number of individual machines/subsystems/devices within or coupled to system 10 being controlled. For example, a first manufacturing system which rapidly produces an article of manufacture (i.e., produces an article of manufacture at a high rate of speed) may require a data sampling rate which is higher than a second manufacturing system which produces an article of manufacture at a rate which is less than the first manufacturing system.

In addition to receiving information/data related to operation of the system being controlled, history memory 16 also receives information/data related to operation of the actor 26 (i.e., what the controller is doing). Information/data stored in memory 16 may be provided to the learning thread. The control system includes a current model of the system to be controlled—i.e., a learned model which captures the dynamics of the system to be controlled (e.g., system 10 in FIG. 1) and actor 26 operates in accordance with the model. Thus, based upon a current model, actor 26 applies voltages and/or currents to various subsystems, machines, devices or circuitry (e.g., motors, heating elements, cooling elements, etc. . . . ) which make up system 10 to get the system to behave in a particular way.

Reward function 28 operates to compare an actual output of the system (e.g., a measure or otherwise determined output of the system) to a desired output. Embedded within or accessible to reward function are values or information representing desired system behavior. The reward function thus operates to calculate or otherwise determine an error (or difference) between an actual output value and a desired output value. Such operation may be in a multi-dimensional space. Neural networks may use optimizing strategies (e.g. stochastic gradient descent) to reduce (and ideally, minimize) the error in the algorithm. A loss function may be used to compute this. The loss function may thus quantify how well or poorly (i.e., how good or bad) a model is performing. Two categories of loss functions are regression loss and classification loss. For example, in some embodiments a mean-square error function may be used. In other embodiments, a more complex function may be used. After reading the disclosure provided herein, those of ordinary skill in the art will appreciate how to select a particular function to use in a particular application. Thus, reward function 28 quantifies (e.g. assigns a numeric value) a comparison between actual data (or value) (i.e., representing actual system behavior) and desired data (or value) (i.e., representing a desired system behavior).

In overview, learning thread 17 operates such that stored history (i.e., the data/information stored in memory 16) is compared to the current model. If as a result of such comparison it is determined the recent history differs from the past history, then the learner portion of control system 12 determines how to improve a current model. That is, the current model is updated/modified/improved dynamically (or “on-the-fly”) via information from the leaning thread.

Learning portion of control system 12 comprises a critic 18, an update operator 20, a target critic 22 and a target actor 24 all of which receive data from memory 16. Thus, learning thread 15 is implemented via critic 18, target critic 22 and target actor 24 (each of which may comprise a neural network) and update operator 20. In embodiments, critic 18, target critic 22, target actor 24 and actor 26 are provided as long short-term memory (LSTM) neural networks.

Critic 18 operates to perform a comparison between blocks of data from history memory 16 (i.e., critic 18 may be considered to perform a quantified comparison between blocks of data over history—e.g., critic 18 says the current history is different or worse than prior history).

In response to a desired metric or characteristic of an article of manufacture and target actor 24 may simulate/generate an improved model of the system which may be used by actor 26. For example, in the illustrative learner of FIG. 1, if one were to simulate what the controller 26 would do with this new model (i.e., if one were to say “given a target of what is trying to be achieved, by modifying a model in the controller in a particular way, then with the given understanding of history and a current estimate of what the system should look like, the target actor may simulate a better model of the system being controlled). In other words, learning as implemented via the learning thread is the act of internally developing an improved model for the system (i.e., simulating what an improved set of control signals would look like compared with control signals generated using an existing model).

It should be appreciated that training (or learning) thread 17 continuously simulates system behavior (e.g., how the system would behave/perform with a modified or new model) using values from the currently implemented model (i.e., actor 26 operates in accordance with an existing model and applies control signals to system 10 in accordance with the model existing at that time).

If it is found via such simulations that a model (or configuration) which differs from the existing configuration (e.g., the configuration as implemented in or via actor 26) which would yield a better result, then the system has learned information and that information is fed as an actor update from the target actor (via the target critic) to the actor 26. Stated differently, the learning thread 17 generates a new (or modified) model which may be used by the control thread to control the system (i.e., the control thread which generates signals via actor or controller 26 to control hardware in system 10).

As noted above, the DRL control system 12 and techniques described herein find use in wide variety of applications (e.g., any system which requires control of a process). With that in mind, next described is one example of a manufacturing system and process—specifically, a system and process for manufacturing optical fiber—controlled by a DRL control system operating in accordance with the concepts described herein.

Existing systems for the manufacture of optical fiber include conventional control systems (or controllers) which operate based upon accurate modeling of an optical fiber drawing process. Such conventional control systems and processes have been developed to control physical characteristics of an optical fiber resultant from the a fiber drawing process and system. One characteristic of an optical fiber which may be desirable to control is a diameter of the optical fiber. Thus, some prior art optical fiber manufacturing processes and control systems focus on maintaining optical fiber diameter at a fixed value (or a fixed “set point”). When set points change, however, control systems and techniques must be modified (e.g., control models having new set points are required).

However, in accordance with the DRL control concepts, systems and techniques described herein, a fiber manufacturing system and associated DRL control system is described which allows the manufacture of optical fiber having varying geometries, which may be made from differing materials, and which may be manufactured using varying fabrication methodologies. That is, the DRL control system and concepts described herein are able to adapt to different and/or changing parameters/characteristics of a manufacturing process.

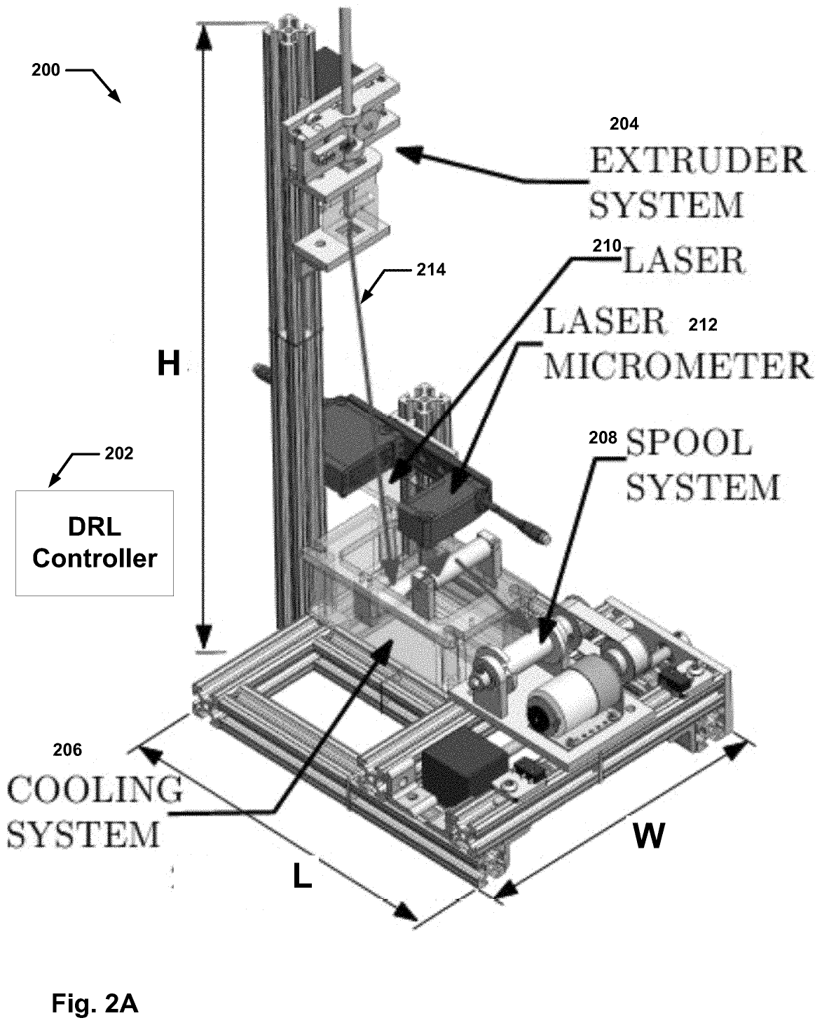

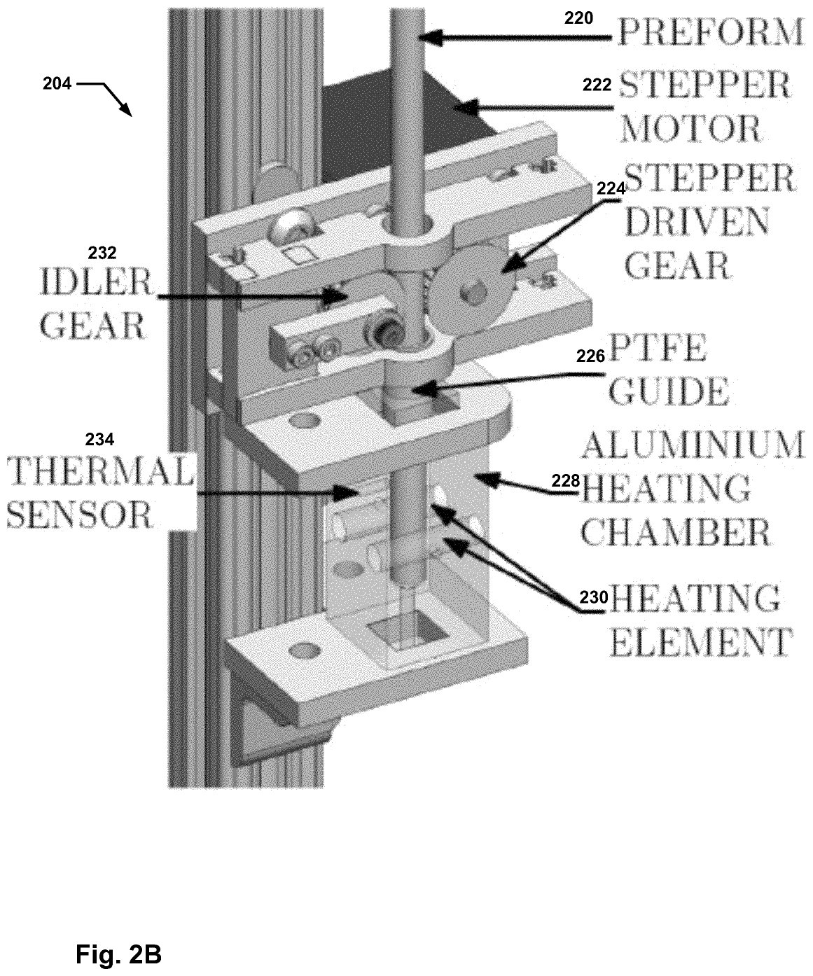

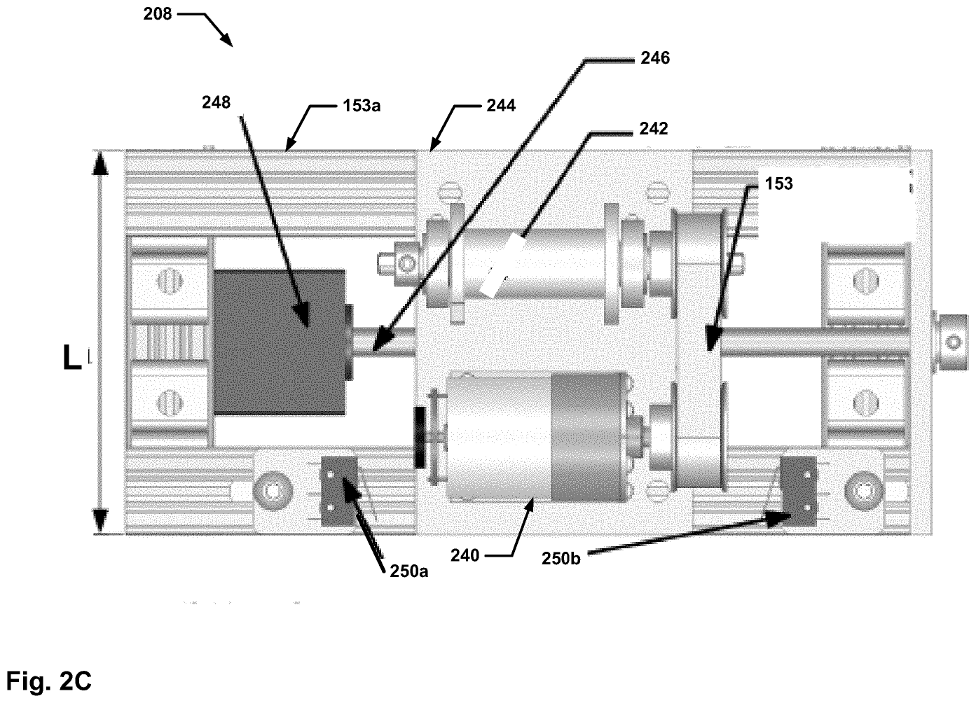

Referring now to FIGS. 2A-2C, in which like elements are provided having like reference designations, shown is small scale fiber production system 200 (also sometimes referred to herein as a fiber drawing system) comprising a DRL controller 202. In embodiments, DRL controller may be implemented within any processor or processing device of system 200 or within multiple processors or processing devices within system 200 (i.e., the functionality of DRL controller may be distributed across a plurality of processors). In some embodiments, DRL controller may not be part of system 200 per se but rather may be coupled to system 200 and may be implemented in a processor separate from processors which are properly a part of system 200. DRL controller 202 may be the same as or similar to DRL controller 12 described above in conjunction with FIG. 1. In this example embodiment, however, DRL controller 202 has been trained over one or more characteristics of an optical fiber (not visible in FIGS. 2A-2C) and/or one or more characteristics of a fiber drawing system. Thus, in this example embodiment, the optical fiber is the article of manufacture produced by fiber drawing system 200 and DRL is also used to teach (or train) controller 202 to track a dynamically varying reference trajectory of one or more characteristics (e.g., fiber diameter) of the optical fiber being manufactured.

It should be appreciated that in this example, the mechanical configuration of fiber production system 200 is implemented to increase accuracy and stability of the mechanical design of the fiber drawing system. The fiber production system comprises an extruder subsystem 204, a cooling subsystem 206, a spooling subsystems 208, a laser subsystem 210 and a laser micrometer 212.

Referring now to FIG. 2A, the arrow identified with reference numeral 214 in FIG. 2A illustrates the general path of a fiber through the fiber drawing system 200. In general overview, a fiber enters and exits extruder subsystem 204 and then passes through cooling and spooling subsystems 206, 208. The fiber also passes through laser micrometer 212 for diameter measurement before being exposed to coolant in the cooling system 206. After the fiber exits the cooling system, the fiber enters the spool system 208.

Referring now to FIG. 2B, the extruder subsystem comprises a heating chamber 228 and a feeding actuator. In this example embodiment, the feeding actuator comprises a motor 222, a first gear 224 and an idler gear 232. In embodiments the motor may be provided as a stepper motor and gear 224 is provided as a stepper driven gear. The feed-rate is controlled by the motor speed (e.g. by the stepper motor speed). As the feed-rate increases, the fiber diameter increases given a fixed spool velocity.

The heating chamber comprises a temperature sensor 234 and heating elements 230 to control the temperature. The heating chamber comprises a hole having a diameter larger than the preform diameter and through which the preform is placed as illustrated in FIG. 2B and the feeding actuator feeds a preform 220 through the hole and into the heating chamber at a controlled speed.

In this example embodiment, the heating chamber has two (2) cartridge heaters 230 each operating at a predetermined power level (e.g. 40 W). In other embodiments, heating chamber may comprise fewer or more that two heating cartridges. In still other embodiments, heating chamber may comprise a different means for heating a preform. Also in this example embodiment, the heating chamber comprises a resistance temperature detector (RTD) (not visible in FIG. 2B) to measure the temperature of the chamber.

Referring now to FIG. 2C, spool subsystem 208 is shown. A function of spool system 208 is to collect the fiber and to provide speed feedback to control the fiber diameter. As the spool spins faster, the fiber goes under tension (i.e., the fiber is subject to a tension force) and the fiber diameter reduces given a fixed feed-rate.

In this example embodiments, spool subsystem 208 comprises a motor 240 (e.g. a DC motor) with an encoder attachment (not visible in FIG. 2C). Motor 240 is coupled to spool 242 via a timing belt 243. Motor 240 causes spool 242 to rotate. Motor 240 and spool 242 are mounted or otherwise coupled to a stage 244. Stage 244 is coupled to a motor 246 and lead screw 248 which actuate and stage 244. Thus, stage 244 moves in response to motor 246 and lead screw 248. In some embodiments, motor 248 may be provided as a stepper motor. The stage movement along the lead screw allows the fiber to be spread out evenly on spool 242. Spool system 208 further comprises limit switches 250a, 250b which operate to limit the range of linear motion of stage 244 to ensure the fiber does not go off the spool's ends. The spool's angular speed and the fiber diameter are measured by the motor encoder and the laser micrometer (FIG. 2A).

As will be described hereinbelow in detail, a learning technique is used to train controller 202 (FIG. 2A) for use in fiber drawing system 200.

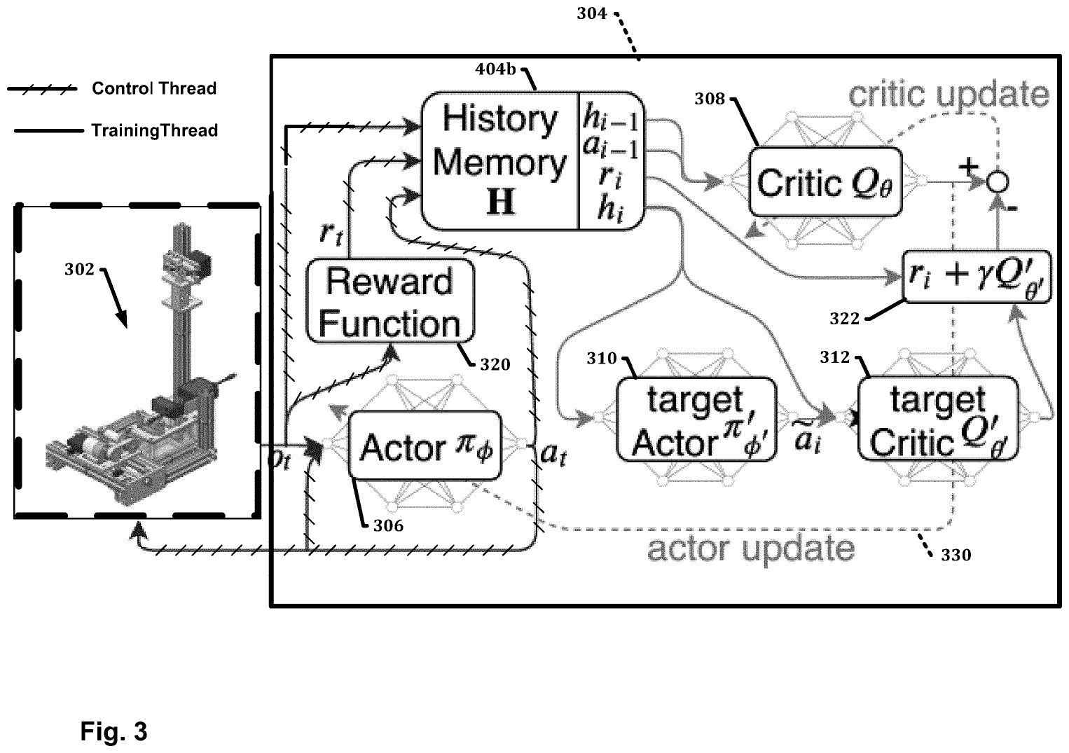

Referring now to FIG. 3, a fiber production system 302, which may be the same as or similar to fiber production system 200 described above in conjunction with FIGS. 2A-2C, is coupled to a DRL controller 304. FIG. 3 illustrates an overview of a learning method for the DRL controller 304. In this DRL fiber control system example embodiment of FIG. 3, it is desirable to tightly control a diameter of a fiber cable. To achieve such tight control of fiber cable diameter, control system controls operation and/or characteristics of the fiber manufacturing system including, but not limited to, heating subsystem temperature, cooling subsystem temperature (which effectively control, at least in part, viscosity/density of the fiber material) as well as velocities of the spooling subsystem and the velocities at which fiber material enters and exits the fiber production system 302. The DRL control system may thus modulate the velocities of the fiber entering and exiting the fiber production system 302 to assist in closely controlling fiber diameter (i.e., maintaining the fiber diameter to a target value within small tolerances).

In the example embodiment of FIG. 3, the DRL control system 302 comprises four long short-term memory (LSTM) components. LSTM components correspond to or comprise respective ones of an actor component π_{φ} 306 a critic component Q_{θ}, 308 a target actor component π′_{φ′} 310 and a target critic component Q′_{θ′} 312 wherein φ, θ, φ′, θ′ correspond to the parameters of each network.

In embodiments, the neural networks discussed above (e.g., the network of LSTM neurons) are manipulated in three ub-processes: initialization, control thread, and train thread. The control thread and train thread subprocesses operate as described above in conjunction with FIG. 1 and as also described above, the control and train threads concurrently execute throughout the entire process. In embodiments, the control and train threads run simultaneously throughout an entire control process (i.e., the control and train threads execute as long as the control system is controlling a system (e.g., a system to produce an article of manufacture). The initialization sub-process is the initialization of the entire neural network and brings the numerical model of the system (e.g. as stored in a memory of one or more processors or one of more processing circuits) into agreement (or substantial agreement) with a current state (e.g. a current initialized state) of the hardware to which the control system is coupled—e.g., the current initialized state of components (e.g. hardware components) which make up the system being controlled.

In the control thread, sensors attached to the fiber production system 302 (e.g., micrometer 212, temperature sensor 234) observe (oₜ) the state and the actor 306 computes action (aₜ) accordingly. A reward (rₜ) is computed using a reward function 320 as discussed above in conjunction with FIG. 1. These observations, actions and rewards are then stored in a history memory H 404b.

In the train thread, a data sampled from the history memory is fed into a critic and the critic computes a Q-value as an output.

The Q-value (also referred to as a state-action value function Q(s, a)), represents an expected future reward when taking a certain action at a certain state, then thereafter following the agent's policy,

Q^{μ}(sₜ,aₜ)=E[Rₜ|Sₜ=sₜ,Aₜ=aₜ], (1)

where Rt and μ represents the cumulative future reward and the policy of the agent. The cumulative future reward Rt, also called return, is often discounted with a discount factor γ∈[0, 1),

$$\text{?} \qquad ( 2 )$$

$$\text{?} \text{indicates text missing or illegible when filed}$$

where rₜ is the reward at time t. The discount factor γ models the notion that a state and an action have decreased relation with the state and reward that are farther separated in time. Therefore, the reward is discounted at each timestep by multiplying the discount factor γ. As a result, when optimizing the return, the agent is biased to the more recent observations.

One may estimate the Q-value using the Monte Carlo method, where the agent tries an entire episode and takes the average return for each state-action pair. However, it is inefficient since it has to wait until the end of each episode to do learning. Therefore, the Bellman equation is used to solve this issue by bootstrapping the Q-value estimation between consecutive timesteps,

Q^{μ}(sₜ,aₜ)= [symbol] |rₜ+γQ^{μ}(sₜ₊₁,μ(sₜ₊₁))], (3)

It compares the Q-values with a single timestep difference. The error between the left and right side of the equation (3) is called the temporal difference (TD) error. In the TD method, the agent has to wait only until next timestep so the learning can be done online.

In general, the Q-value assists in determining or learning appropriate weights to use in a particular application. That is, the Q-value corresponds to a relative merit of weights applied both over time and over different parameters (e.g., determining how long a period of time different inputs matter). Thus, the Q-value maps, for example, the nature of the system dynamics (e.g., how fast a system responds, natural frequencies and resonances of the system, etc. . . . ).

The amount of data used to improve (and ideally, optimize) system performance relative past system performance may be selected in accordance with the needs of a particular application. In computing Q values, the critic performs computations (e.g., computing gradients). The greater the amount of data used in making such computations (e.g., estimating gradients), the more processing time which is required. Thus, in selecting an amount of data used by the critic to compute a Q value, a trade-off is made between speed and accuracy.

That is, the more data used by the critic, the greater (or higher) the accuracy, but at a speed which is slower than that which could be achieved by selecting less data. Conversely, using less data results in faster processing times (i.e., higher speed) but with less accuracy than could be achieved by using more data. Thus, in applications where speed is of primary importance (or where accuracy is not of primary importance), it may be desirable to sample less than all data in history memory (i.e., a smaller than possible batch of data or a “mini-batch” of data) and provide the min-batch of data to the critic. The particular amount of data to use in a particular application may be estimated (e.g. via a simulation during a learning process as described above) or may be empirically determined.

The Q-value as determined by the critic is then compared with a target value computed by target networks 310, 312. As noted above, target values are selected in accordance with the needs of a particular application. In the above-described application related to a fiber production system, a target value may, for example, correspond to an error value between a target fiber diameter and an actual fiber diameter (i.e., as way to control mechanical tolerances of the fiber diameter). As another example of a target value in the above-described fiber production system, a target value may be related to a temporal scale. For example, if a fiber diameter does vary, a target value may specify that a variation may occur at a scale of 0.5 Hz (or at a scale of 0.001 Hz, for example) with the particular target value (e.g., 0.5 Hz or 0.001 Hz) selected to suit the needs of the particular fiber production system. Thus, the DRL control system may be used to control a metric (or characteristic) for which it is desirable to achieve a zero error over time by comparing an actual (or measured) value to a target value.

The critic may be updated in accordance with such a comparison. In embodiments, the critic may be updated by reducing (and ideally, minimizing) the difference between the Q-value and the target value. Lastly, the actor is updated by increasing (and ideally, maximizing) the critic's evaluation (Q-value).

It should be noted that although the above example applies to a fiber production system, the above described DRL control system is not limited to use with fiber production systems. Rather, the DRL control system as described hereon finds use in a wide variety of manufacturing processes.

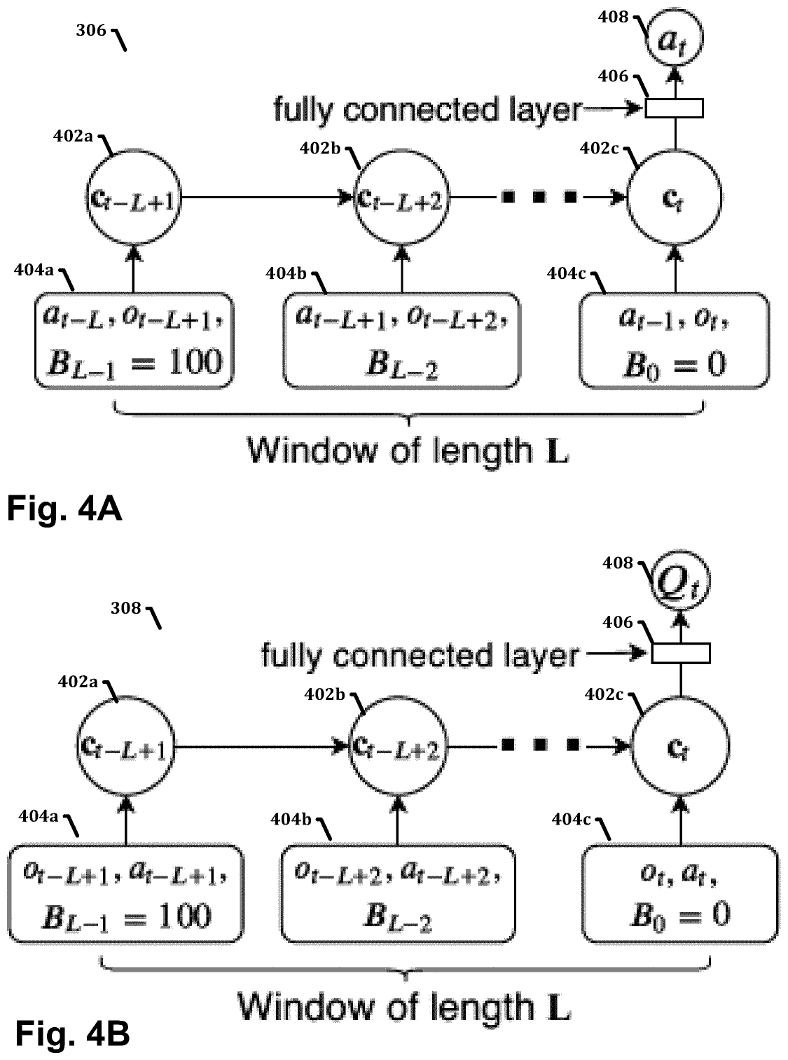

Referring now to FIGS. 4A and 4B, the network structure of the actor 306 and the critic 308 are shown. In embodiments, the structure of the target actor and the target critic may be identical to that of the actor and the critic. Each of the circles (ci) in FIG. 4 represents the LSTM network.

In one example embodiment, the number of layers of each network is set to five and the number of nodes in each layer is set to 512. In other embodiments, the number of layers of each network may be greater than or less than five and the number of nodes in each layer may be greater than or less than 512. The particular number of layers to use in a particular application will depend, at least in part, upon the nature of the complexity of the dynamics of the system to be controlled. In general, the more complex the system, the greater the number of layers which will be required. After reading the disclosure provided herein, one of ordinary skill in the art will appreciate how to select a reasonable number of layers to use in a particular application.

In embodiments, the hyperbolic tangent may be used as the activation function. Functions other than the hyperbolic tangent function may, of course, also be used. It should, however, be appreciated that for mechanical systems, activation functions which are continuous (i.e., continuously differentiable) may be preferred (as opposed to selecting an activation function having a discontinuity). After reading the disclosure provided herein, one of ordinary skill in the art will appreciate how to select an activation function for use in a particular application.

The neural networks recurse through L timesteps where L is a window length (i.e., a span of time where the networks take inputs). Outputs of the neural networks are determined by the inputs that are within the window length. At each timestep, the action taken at one timestep before (aₜ₋₁) and the following observation (Oₜ) is fed into the actor 306. An observation at each timestep (Oₜ) and the following action (aₜ) is fed into the critic. The outputs are computed by passing the activation values of the last recursion through a fully connected layer.

1) Observation (Oₜ): Observation includes the below components:
spool's angular speed (ωt)
fiber diameter (dt)
summation of the extruder feed-rate (Σₜ₌₀fₜΔt)
reference diameter (dₜ^{ref},dₜ₊₁₀^{ref}, . . . ,dₜ₊₅₀^{ref})

As noted above, the spool's angular speed and the fiber diameter are measured by the motor encoder and the laser micrometer.

The summation value of the feed-rate represents the amount of fiber produced during the production run. In this example application, this is important information because the system is a time-variant system due to drawn fiber accumulation. That is, over time, the fiber is drawn and wrapped around a spool, thereby effectively increasing the radius of the spool. Such an increase in spool radius results in an increase in the linear speed of the fiber over time given a fixed angular speed of the spool. Consequently, if the stacking fiber on the spool is not considered and the spool is run with a constant angular speed, the linear speed increases resulting in a changing (i.e., decreasing) fiber diameter. Thus, there is a relation between the summation value and the effective radius of the spool, and therefore the summation value is included in the observation.

In this example, the last component of the observation is the reference diameter. The reference diameter at not only the present timestep but also several future reference diameters are included (10, 20, . . . , 50 timesteps); the observation looks as far as 50 timesteps (12.5 seconds) ahead. Therefore, the agent can predictively control the system based on the future reference diameters.

2) Action (aₜ): Action includes the below components.
spool input (a_{sp,t})
extruder input (a_{ex,t})

The spool input and the extruder input have a value between 0 and 100. The spool input determines the spool motor's PWM duty cycle. The spool input value of 0 and 100 is equivalent to the duty cycle set to 7.8% and 100%, respectively. The extruder input determines the extruder stepper motor's frequency, which is proportional to the feed-rate. The extruder input value of 0 and 100 is equivalent to the feed-rate of 0.09 mm/s and 0.56 mm/s, respectively.

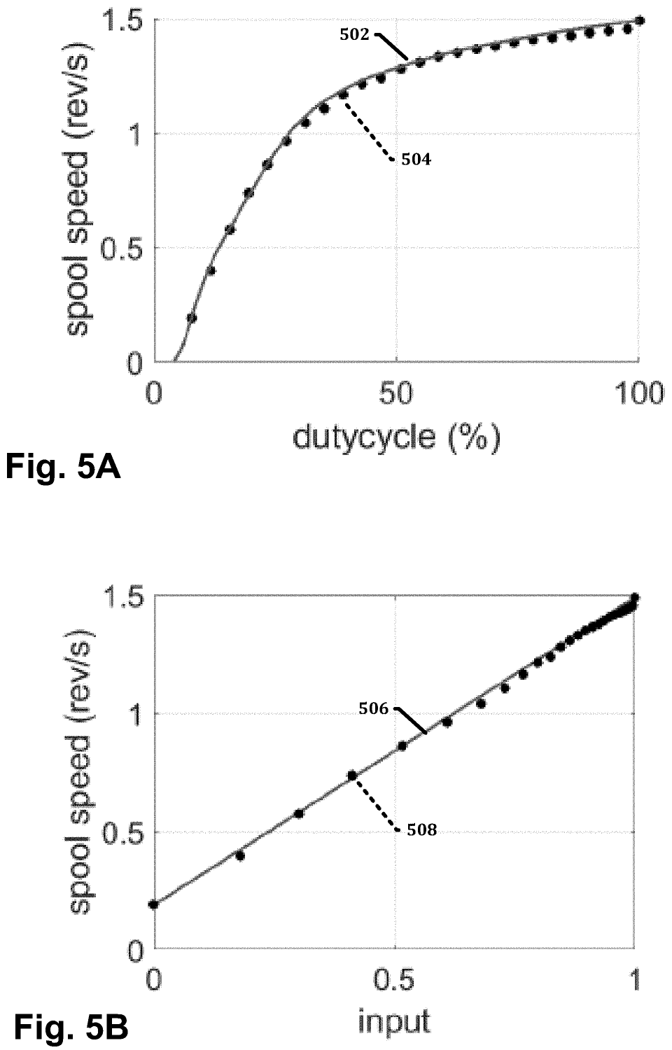

Referring now to FIG. 5A, shown is the relation between the spool motor's duty cycle and the angular speed measured by an encoder. The slope is steeper at the lower duty cycle and flatter at the higher duty cycle. Low velocities are sensitive to the variation of the duty cycle. Consequently, if the spool input (aₛₚ) is mapped just linearly with the duty cycle, then it is hard to precisely control the speed. Therefore, polynomial regression may be performed on the curve of FIG. 5A and convert the spool input so that it has a linear relation with the speed, as shown in FIG. 5B. The extruder input (aₑₓ) is linearly mapped with the stepper motor's frequency, because the feed-rate is proportional to the frequency.

### 3) Window Length (L):

In a prior technique described in the N. Heess, J. J. Hunt, T. P. Lillicrap, and D. Silver, “Memory-based control with recurrent neural networks,” arXiv e-prints, p. arXiv:1512.04455, December 2015, the activation values of an LSTM network are propagated from the beginning to the end of each episode. The gradients are back-propagated to the beginning of the episode, and the updates are done between each episode rather than within the episodes. One problem with this method is that computation time increases as the episode gets longer since the gradient must back-propagate through the entire episode. Therefore, the computational requirement can become a bottleneck to training the model in real-time. In the case of the fiber drawing system, each episode is thousands of timesteps long (tens of minutes). Therefore, the computation time becomes long for each training iteration, which makes it harder to train the model in real-time.

Thus, in accordance with the concepts and techniques described herein, only the time span that significantly affects the state of the system is considered, rather than the entire episode. The length of the window, through which the networks look into the system (FIG. 4) is set. The networks do the computations for control and updates only within the window. The window size should be long enough to capture the delayed dynamics of the system. One of the longest delayed dynamics in the fiber drawing system is the delay between the feed-rate change and the response in diameter. When one applies a step change to the feed-rate, it takes approximately 10 seconds (40 timesteps) for a response to appear in the diameter. Therefore, the window length should be at least 40 timesteps to capture the delayed dynamics.

### 4) When-Label (Bi)

To facilitate the learning, when-labels are concatenated to the inputs. When-labels have scalar values between 0 and 100. It indicates when in the past each observation and action occurred. It forms an arithmetic sequence, where the most recent inputs (B0) have a when-label value of 0 and the oldest inputs (BL−1) in the window have a value of 100 (FIG. 4). Without when-label, the LSTM network processes the inputs in the same way, no matter when the input data is produced. With the when-label, the network can incorporate information about when the data was acquired.

### B. Initialization

In an embodiment, the first step of the process is initializing each network. The parameters of the actor and the critic are initialized. In embodiments, a Glorot initialization may be used. Then, the parameters of the actor and the critic are copied to the target actor and the target critic. The empty history memory H is initialized. Lastly, the recent history buffer h of window length L is initialized. The recent history buffer is a buffer that contains the L most recent observations and actions.

### C. Control Thread

In the control thread the actor receives the observation from the system and computes the action. First, the actor receives the observation (oₜ) and the reward (rₜ) is computed by a reward function. The reward function is defined by the human operator. For example, we can define it as the negative value of error between the measured diameter and the reference diameter. Next, the observation (oₜ) and the previous action (aₜ₋₁) are appended to the recent history buffer h. The actor then takes the recent history buffer as the input and computes a greedy action: π_{φ}(hₜ).

An exploration noise (ϵ) is added to the greedy action before the action is executed:

aₜ=π_{φ}(hₜ)+ϵ. (4)

The exploration noise is required for the actor to consider policies that could be better than the current policy. In embodiments, an Ornstein-Uhlenbeck process with a decay factor β may be used for the exploration noise. The volatility of the exploration is decreased by the factor of β at each timestep. Lastly, the action (aₜ) is executed on the system as the control input. The reward, observation, and action are added to the history memory H at each timestep.

### D. Train Thread

The train thread runs in parallel with the control thread. First, N samples of memory slice, which have a length of L+2, are sampled from the history memory H:

(r_{i-L-1},o_{i-L-1},a_{i-L-1}, . . . ,rᵢ,oᵢ,aᵢ) (5)

The target yⁱ is computed by the target networks:

hᵢ←(a_{i-L}o_{i-L+1}, . . . ,aᵢ₋₁,oᵢ) (6)

ãᵢ←π′_{θ′}(hᵢ),yᵢ←rᵢ+γQ′_{θ′}(hᵢ,ãᵢ) (7)

The target value yⁱ is used as the right hand side term of (3). Then, the loss J (mean squared TD error) of the critic network becomes:

$$J = \frac{1}{N} {\sum }_{i} {( {y}_{i} - \text{?} ( {h}_{i - 1} , {a}_{i - 1} ) )}^{2} . \qquad ( 8 )$$

$$\text{?} \text{indicates text missing or illegible when filed}$$

TABLE I

| Parameter | Value |
|---|---|
| Minibatch size (N) | 32 |
| Actor learning rate | 1e−6 |
| Critic learning rate | 5e−6 |
| Soft update factor (τ) | 0.05 |
| History memory (H) size | 75,000 |
| Discount factor (γ) | 0.99 |
| OU volatility/speed/decay rate (β) | 10/0.1/0.999925 |
| window length (L) | 50 |

The critic gradient that decreases J can be computed with BPIT:

$$Δθ = \frac{1}{N} {\sum }_{i} ( {y}_{i} - {Q}_{θ} ( {h}_{i - 1} , {a}_{i - 1} ) ) \frac{\partial {Q}_{θ} ( {h}_{i - 1} , {a}_{i - 1} )}{\partial θ} . \qquad ( 9 )$$

By applying the gradient, the critic parameter θ is updated. In embodiments, a gradient descent optimizer is used. In embodiments, the gradient descent optimizer may be provided as the Adam optimizer. After updating the critic, the actor parameter φ can also be updated by applying gradient that increases the Q-value. The chain rule is used to compute the gradient,

$$Δϕ = \frac{1}{N} {\sum }_{i} 𝒞 ( \frac{\partial \partial {Q}_{θ} ( {h}_{i - 1} , {π}_{θ} ( {h}_{i - 1} ) )}{\partial a} ) \frac{\partial {π}_{ϕ} ( {h}_{i - 1} )}{\partial ϕ} , \qquad ( 10 )$$

where C(⋅) is a transformation, which bounds actions between the maximum and the minimum.

$$𝒞 ( {∇}_{a} ) = \{ \begin{matrix}{∇}_{a} \cdot ( {a}_{max} - a ) / ( {a}_{max} - {a}_{min} ) , \\ if {∇}_{a} suggests increasing a and a > {a}_{max} \\ {∇}_{a} \cdot ( a - {a}_{min} ) / ( {a}_{max} - {a}_{min} ) \\ if {∇}_{a} suggests decresing a and a < {a}_{min} \\ {∇}_{a} , otherwise\end{matrix} \qquad ( 11 )$$

Lastly, the target actor and the target critic is updated by applying the soft update,

(θ′,ϕ′)←(rθ+(1−r)θ′,τϕ+(1−τ)ϕ′), (12)

where τ is a very small positive scalar value. Soft updates of the target networks enable the stable con-vergence of the model.

### 1) Hardware System and Hyperparameters:

A fiber production system (e.g. fiber system 200 of FIGS. 2A-2C) was operated with a DRL controller provided in accordance with the concepts and techniques described herein.

The temperature of the heating chamber was set to 80° C., where the fiber drawing is stable with minimal diameter fluctuation. Ethylene-vinyl acetate (Adtech W220-3824 glue-sticks) and room temperature water were used as the material and coolant. Neural network computation was performed on Nvidia's RTX 2080. Sensor measurements and computation results were received and transmitted to PJRC Teensy 3.5 board, an Arduino-based microcontroller. The Teensy 3.5 then controlled the motors and drivers based on the computation results. The timestep was set to 250 ms (4 Hz). The parameters of the algorithms were set to the values in Table I.

### 2) Reward and Training Reference Diameter Trajectory Design: The Reward Function was Defined as,

rₜ=|dₜ−dₜ^{ref}]+αfᵢ+C, (13)

Where a and C are positive scalars, and d and d^{ref} are in units of one-hundred microns. The first term (|dₜ−dₜ^{ref}|) represents the error between the reference diameter and the measured diameter at each step. The reward decreases as the error increases. The second term (αfₜ) is proportional to the feed-rate of the material and thus represents the mass production rate of the fiber. The value of α was set to 0.106 s/mm, which scales the second term to approximately one-tenth of the first term. This term is needed to ensure the uniqueness of the input action combination. There are two input actions (the spool speed and the extruder feedrate), which regulate a single output measurement (diameter). Therefore, multiple input action combinations will yield a similar diameter.

For example, a combination of a high spool input and a high extruder input can lead to a similar diameter as when a low spool input and a low extruder input is used. However, by adding the second term, the model chooses the combination that maximizes the production rate when there are several other options with similar diameter output. The offset term C was set to 1. If there were no offset term, the reward will be negative at most times. This will lead the model to think that the actions in the operable action range (αₘᵢₙ˜αₘₐₓ) are worse than the actions that are outside of the operable range, especially at the early stage of the learning. In this case, the action can be trapped near the operable boundary.

To train the model so that it can track setpoint step changes, a training reference diameter trajectory that includes random step changes was used for training. The duration for each setpoint was 120 timesteps (30 seconds). Setpoint diameter for each step was randomly selected from a uniform distribution between 300 μm and 600 μm.

### 3) Baseline Methods:

The performance of the trained model was compared against three baseline methods. Mass Conservation Model is a model based on the principle that the mass flow rate of the raw material is the same as the mass flow rate of the drawn fiber:

v_{preform}A_{preform}=v_{fiber}A_{fiver}=rₛₚₒₒₗωₛₚₒₒₗA_{fiber}, (14)

in which:

where v is linear speed;
A is cross-sectional area;
r is radius; and
ω is angular speed.

This model assumes a constant rₛₚₒₒₗ, which means that it does not consider the increase of the effective radius due to the fiber stacking up on the spool.

PI Control regulates the diameter by feedback of the diameter error. P and I parameters were manually optimized at the set point diameter of 550 μm. The material feed-rate was fixed to 0.37 mm/s and only the spool-speed was controlled with PI control.

Quadratic Dynamic Matrix Control (QDMC) is a type of model-based control that uses the step response model of the system. Under the assumptions that the system is linear and time-invariant, it predicts the future diameter and optimizes the present and future inputs by minimizing the cost function:

$$J = {\sum }_{i = 1}^{p} {( \text{?} - {\hat{d}}_{i + 1} )}^{2} + r {\sum }_{i = 0}^{c - 1} {‖ Δ {u}_{t + i} ‖}^{2} , \qquad ( 15 )$$

$$\text{?} \text{indicates text missing or illegible when filed}$$

in which:

\hat{d} is the predicted diameter in 100 μm.
Δuₜ₊ᵢ is the input change;
p is the prediction horizon; and
c is the control horizon.

In this example embodiment, p is set to 50 because the DRL controller looks 50 timesteps ahead as explained in IV. c is set 25, half of the prediction horizon. r is a weighting factor that defines ratio of importance between output error and input change.

The model requires the response in diameter to a step change of each input. The square root of the extruder feed-rate (\sqrt{f}) and reciprocal of the square root of command spool-speed (1/\sqrt{ω}) were used as the inputs since the diameter is proportional to \sqrt{f}/ω according to the mass conservation principle. Each input is normalized such that the minimum and maximum are 0 and 1. The diameter response to the step change of \sqrt{f} was measured at spool-speeds of 0.6, 1, 1.4 revolution/second, then the average response was used for the step response model. For the diameter response to the step change of 1/\sqrt{ω}, the average response at extruder feed-rates of 0.19, 0.37, 0.56 mm/s was used for the model.

The weighting factor r was also tuned. If it is too large, the input changes too slow and results in a slow diameter response. If too small, the input responds too sensitive to disturbances or model error and results in fluctuation in diameter. Weighting factors of 5, 10, 20, 40, 80, 160, 320 were tested on the same reference diameter trajectory that was used for the training of the DRL controller. The mean error increased significantly at a weighting factor of 5 and 320. Between 10 and 160, the mean error difference was less than 10%. Therefore, r was set to 40.

### B. Experimental Result

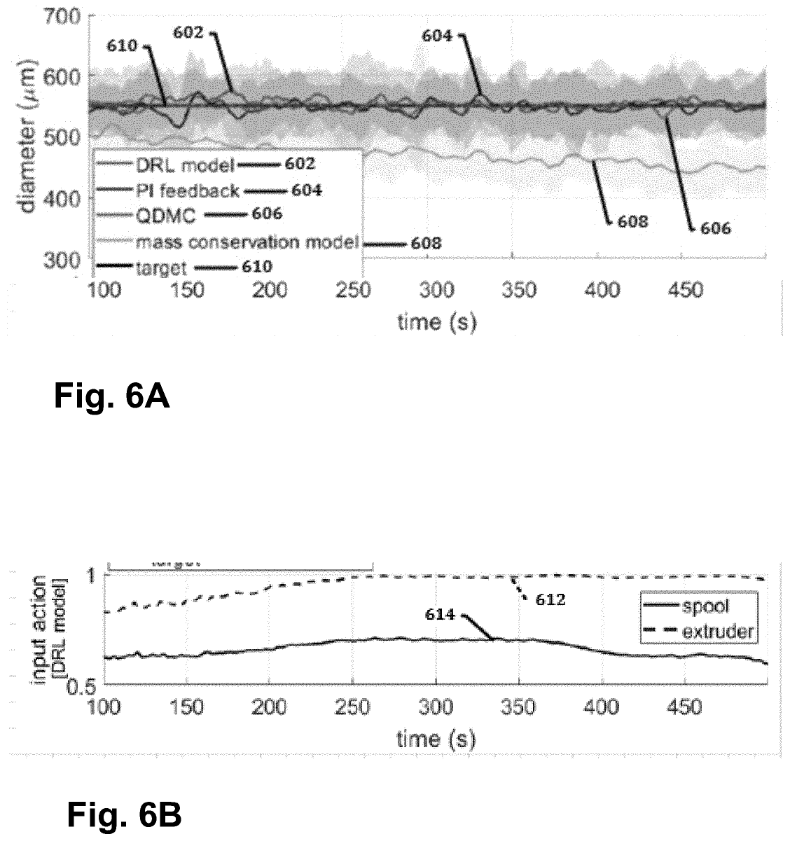

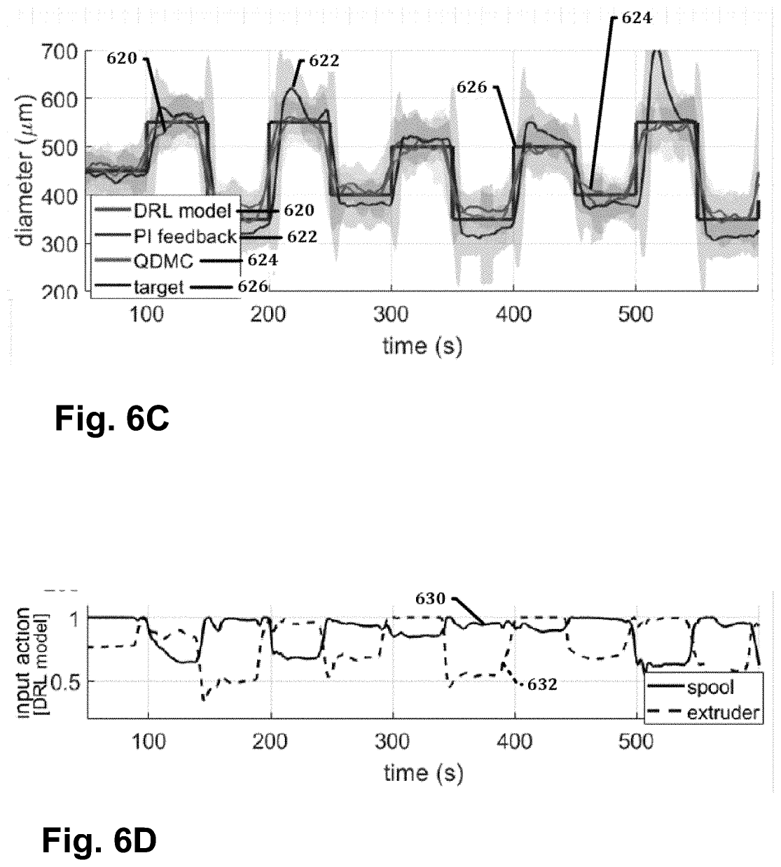

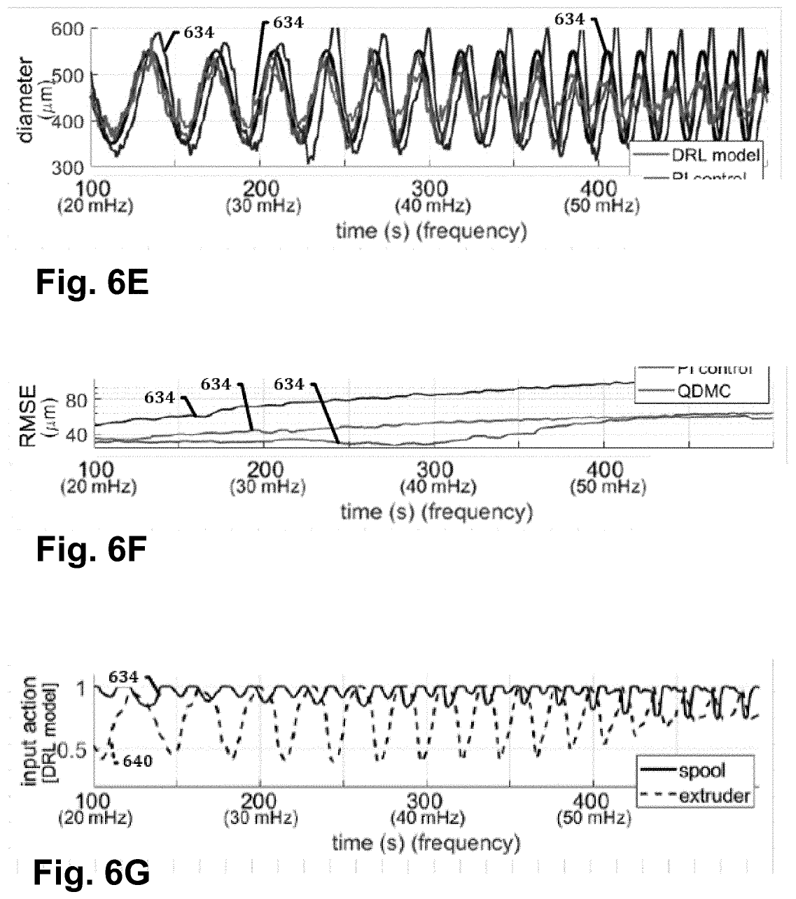

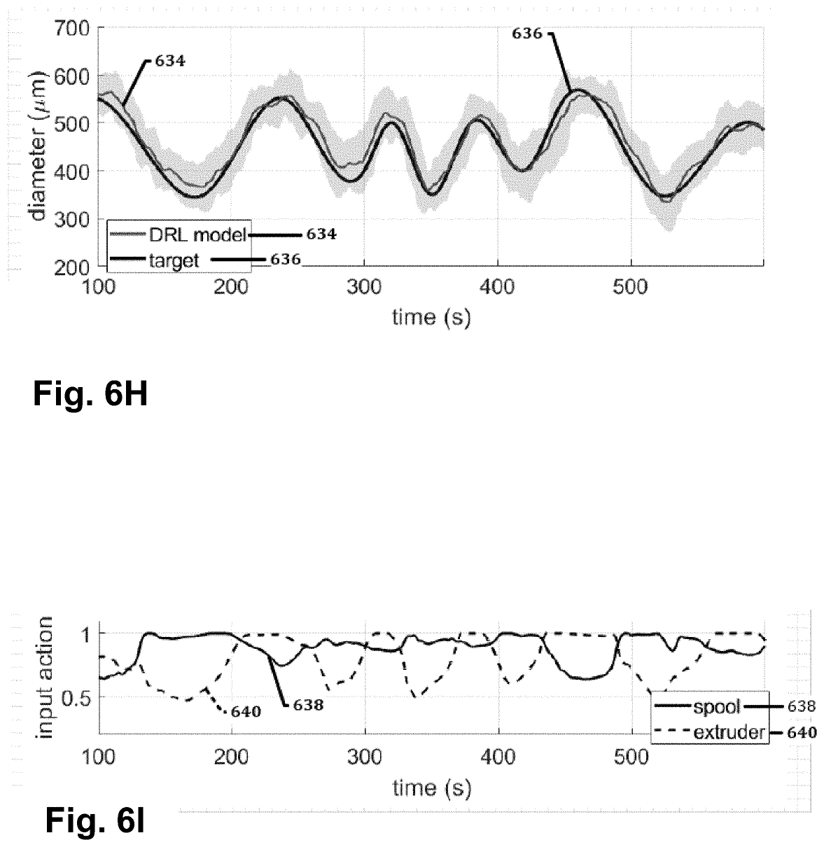

1) Test on Various Reference Trajectories: The DRL controller was trained for approximately 50,000 timesteps (3.5 hours), then tested on several reference trajectories: steady, random step, sine sweep, and random spline. The diameter trajectories and input actions of the DRL controller are plotted in FIG. 6. Each controller was tested 5 times for each of trajectories and the average responses are shown in the plot. In FIGS. 6A, 6B, and 6D, moving average of 40 timesteps is applied and moving standard deviation (×1.96) is shown as the shaded areas.

a) Steady Trajectory: Each controller was tested with the steady reference trajectory at setpoint 550 μm (FIG. 6A). For the mass conservation model, as expected, there was a decreasing trend of diameter with respect to time. As discussed in section V-A3, the simple model does not consider the increase in the spool radius and maintained the constant angular speed, the linear speed of the fiber increased and the diameter decreased with respect to time. In comparison, the DRL control, PI control, and QDMC maintained diameter close to the reference. In DRL control, the ratio of the extruder input (material feed-rate) to the spool input increased with respect to time. In this way, the effect of the stacking spool is compensated by feeding more material and rotating the spool slower. The DRL controller showed an average diameter (551.3 μm) and a standard deviation (29.3 μm) similar to that of the PI control (545.5/25.9 μm) and QDMC (548.6/28.4 μm).

b) Random Step Trajectory: The random step reference trajectory used for testing had an interval of 50 seconds (FIG. 6B). When the PI controller was used for this trajectory, measured diameter response showed 5.7 seconds of average time lag estimated by the cross correlation analysis. It sometimes was not able to settle to the reference diameter within a single interval and sometimes it showed underdamped overshoot. In contras, the DRL controller and QDMC only showed—0.5 seconds and 0.5 seconds of time lag, respectively. They manipulated input actions in advance to the step changes. For the DRL controller, the spool input changed 4.5 seconds ahead of the steps and the extruder input changed 8.0 seconds in advance to the steps, both estimated by the cross correlation analysis. This is consistent with the intuition that pulling the fiber from the spool induces faster response in diameter than feeding material from the extruder. This predictive control was possible since we fed into the DRL controller the information about the future trajectory as the observation. The DRL networks perceive the future reference trajectory as far as 50 timesteps (12.5 seconds) away so it can handle the dynamic change that happens within less than 12.5 seconds.

c) Continuous Trajectory: Again, the DRL controller was trained using a discontinuous step-changing reference trajectory. We tested on continuous reference trajectories: sine sweep and random spline (FIGS. 6C, 6D). The sine sweep trajectory swept from 0.01 Hz to 0.06 Hz with a sweeping rate of 10-4 Hz/s.

The mean and the amplitude were fixed to 450 μm and 100 μm. The random spline reference was generated by connecting several points with a B-spline curve. The diameters of each spline points were set between 350 μm and 550 μm and the timestep difference between adjacent points were set between 20 timesteps (5 seconds) and 80 timesteps (20 seconds), introducing multiple frequency components with multiple amplitude.

In the sine sweep trajectory (FIG. 6C), all of the controllers showed the increasing trend in root mean squared error (RMSE) as the sine frequency increases because there is a physical limit on how fast the system can respond to the input changes. The PI controller showed significantly larger RMSE than other methods at all frequency range. The DRL controller and QDMC showed similar RMSE at below 20 mHz. Between 20 mHz and 50 mHz, the DRL controller showed less RMSE than QDMC. The DRL controller regulated the RMSE to under 40 μm until the frequency reached 45 mHz, while QDMC was able to regulate only until 25 mHz. The DRL controller also tracked the random spline trajectory by gradually varying the input actions (FIG. 6D).

As noted above, QDMC assumes the linear and time-invariant (LTI) system. However, fiber drawing systems may not be linear. For example, the diameter response to the step change in spool velocity is asymmetric depending on whether the velocity changes from low to high or high to low. Also, the system is not time-invariant because the produced fiber increases the effective radius of the spool as it is wrapped around the spool. Therefore, the error occurs in the QDMC's prediction and may results in suboptimal performance. While this is not a critical problem when tracking steady reference trajectory or step change reference trajectory with long step interval, it may be critical when the reference diameter fluctuates violently as that shown in FIG. 6C.

On the other hand, since the DRL controller uses a neural network (NN) and the NN can approximate non-linear function, the DRL controller can learn how to deal with the nonlinearity of the system to some extent.

The results with continuous reference trajectories suggest that the learned DRL controller can be used for not only specific types of trajectory but also other various trajectories that it has never faced during the training process. Such generalization is enabled by using NN an non-linear function approximator for the actor and critic.

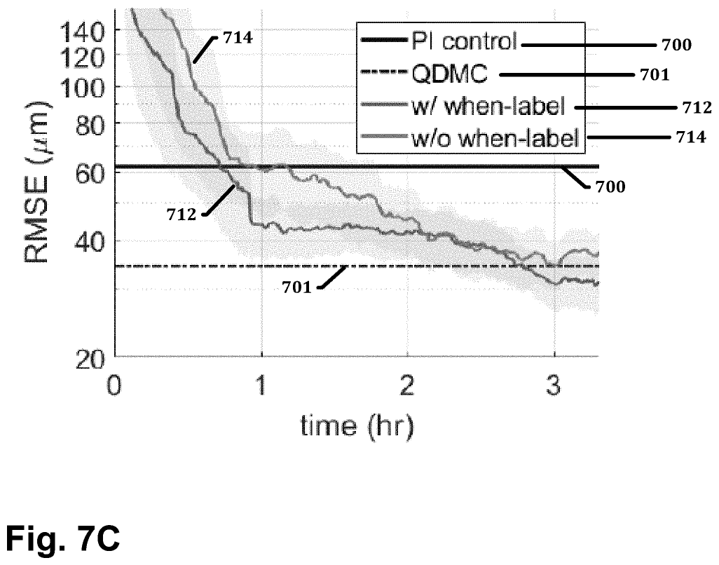

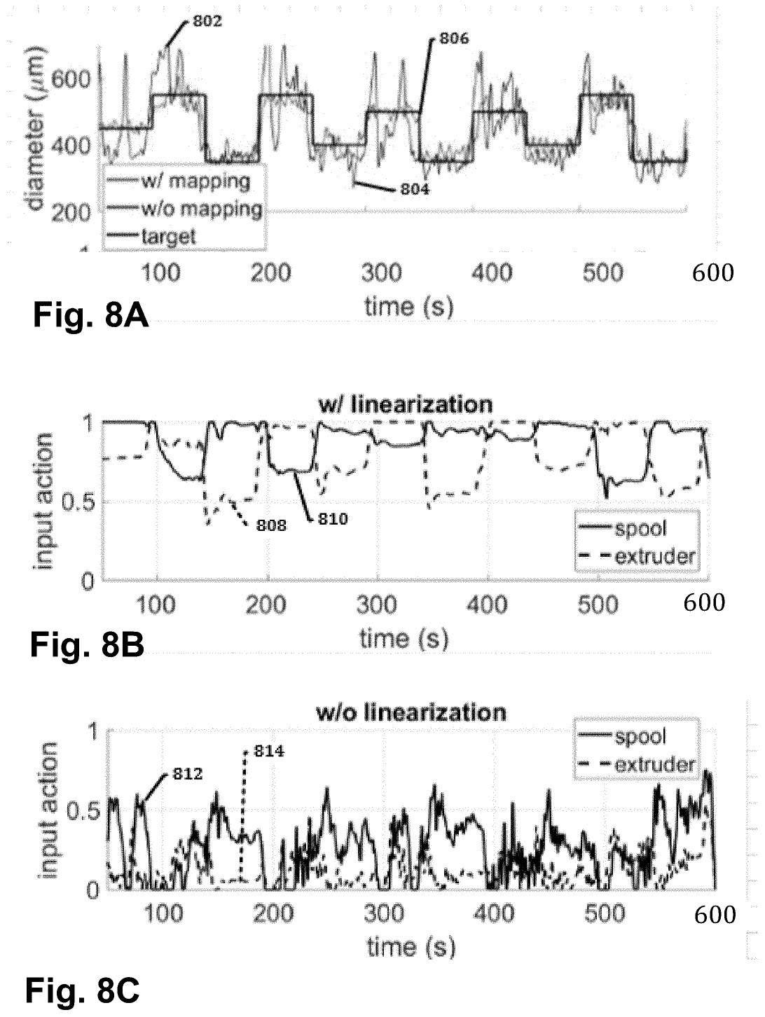

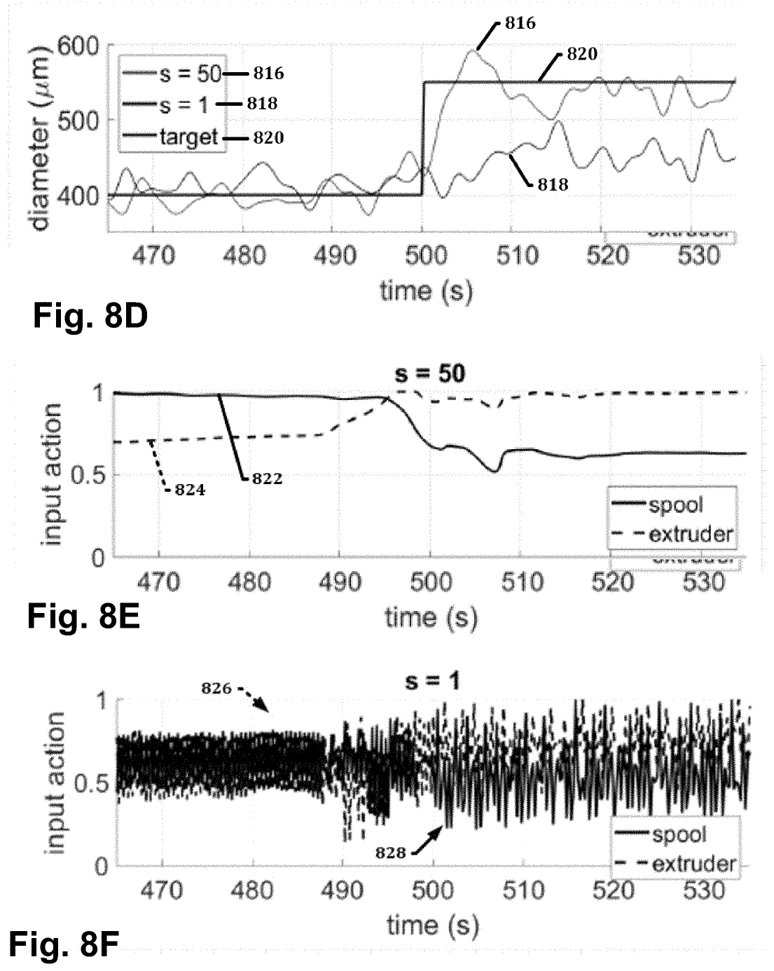

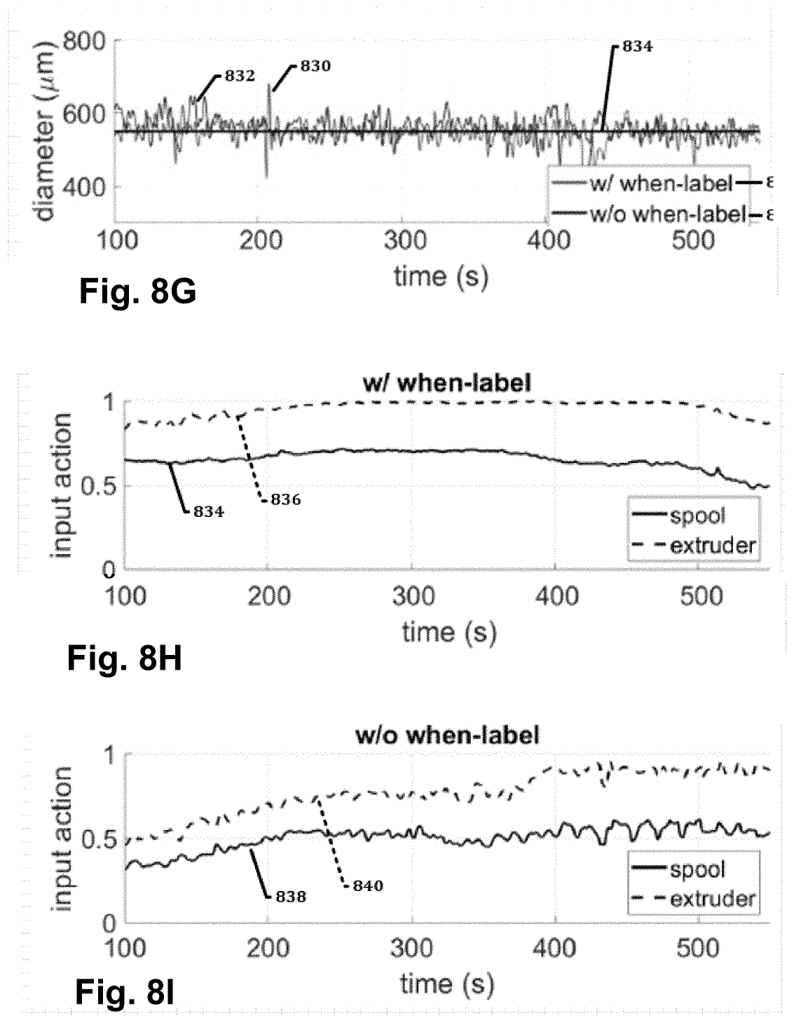

Use of such approximator may fluctuate violently as shown in FIGS. 8D-8F. The model with window length 25 was also not as good as that with window length 50. This is because 25 timesteps (6.25 seconds) are not enough to capture the delayed dynamics when the step change occurs. As described previously, change in the extruder input should occur 8.0 seconds earlier than the diameter step change. Therefore, the window length should be at least 32 timesteps (8.0 seconds) to capture these delayed dynamics are essential for generalizing to large state spaces.

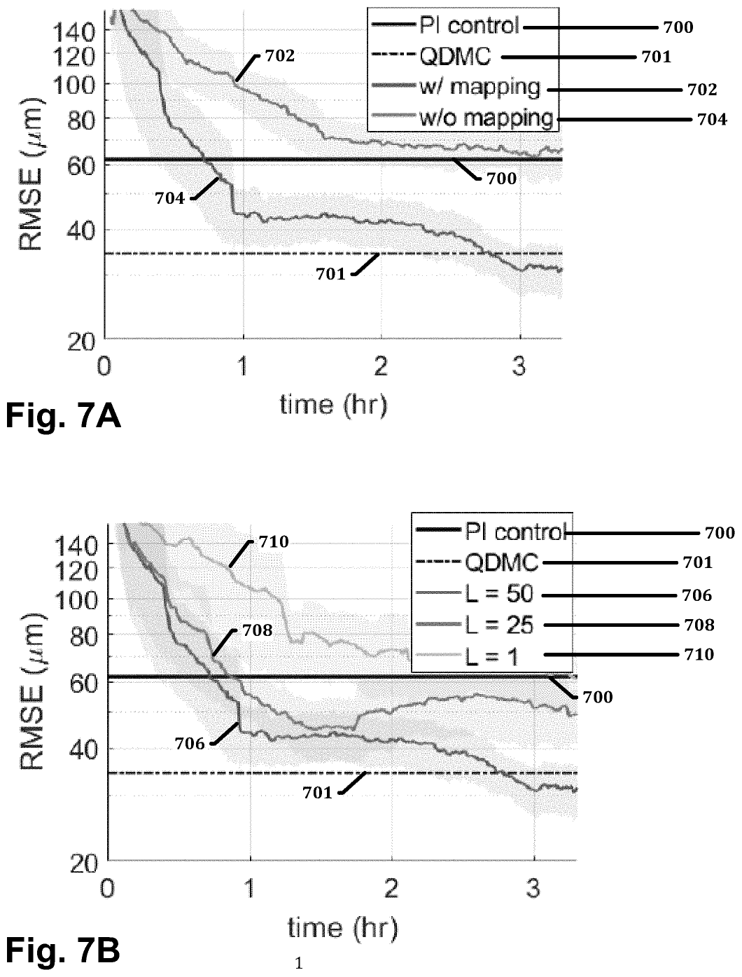

Effect of Action-Speed Linear Mapping: FIG. 7A shows that the action-speed linear mapping is critical to achieving a good performance. The model without the linear mapping converged to the average reward approximately 0.2 smaller than the model with the mapping. This means that the average diameter error was approximately 20 μm bigger. The model showed poor performance especially when the reference diameter was large, where low spool-speed is required (FIGS. 8A-8C). This is because it is difficult to control the speed precisely at the low speed range if action-speed is not linearly mapped. Linearly mapping the spool action to the speed enables the model to control the speed precisely throughout the entire speed range and result in better performance.

Effect of Window Length: Models with several different window lengths are compared. The learning curve comparison shows that the window length must be long enough to achieve optimal performance (FIG. 7B). When the window length is 1, it computes the input action based on only one timestep of observation. Therefore, it does not use the previous history of the process. Also, it cannot capture the stochastic nature of the system. As a result, the computed input action fluctuates violently as shown in FIGS. 8D-8F. The model with window length 25 was also not as good as that with window length 50. This is because 25 timesteps (6.25 seconds) are not enough to capture the delayed dynamics when the step change occurs. As described previously, change in the extruder input should occur 8.0 seconds earlier than the diameter step change. Therefore, the window length should be at least 32 timesteps (8.0 seconds) to capture these delayed dynamics.

Effect of When-label: FIG. 7C shows that the when-label accelerates the learning, especially at the beginning. The when-label helps the learning of the model by providing additional information about when the data was observed. Thereby, the model can learn the dynamics of the process faster than when the label is not provided. Also, the model with the when-label computed more consistent outputs. In comparison, the model without when-label showed some fluctuation in its outputs, as shown in FIGS. 8G-8I. This high-frequency fluctuation is unnecessary since the system does not respond to the high frequency.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to providing element “A” over element “B” include situations in which one or more intermediate elements (e.g., element “C”) is between element “A” and element “B” as long as the relevant characteristics and functionalities of element “A” and element “B” are not substantially changed by the intermediate element(s).

The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs.

The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A process control system comprising:
four long short-term memory (LSTM) networks, the LSTM networks corresponding to respective ones of an actor component π_{φ}, a critic component Q_{θ}, a target actor component τ′_{φ′} and a target critic component Q′_{θ′} wherein φ, θ, φ′, θ′ correspond to the parameters of each network;
manipulating the four LSTM networks in a plurality of sub-processes with a first one of the sub-processes corresponding to a control thread and a second one of the sub-processes corresponding to a training thread;
means for computing a reward (rₜ) using a reward function;
a history memory H configured to store one or more of observations, actions and rewards;
means for sampling data from the history memory;
means for providing the sampled data to the critic component and in response thereto, the critic component provides a Q-value as an output thereof;
means for comparing a Q-value provided by the critic component with a target value provided by one or more target actors;
means for updating the critic component according to a comparison between the Q-value and the target value; and
means for updating the actor component according to the Q-value determined by the critic component.

2. The process control system of claim 1 wherein the actor component is configured to apply one or more control signals to a system being controlled.

3. The process control system of claim 1 wherein the control thread and the training thread concurrently execute throughout the entire process.

4. The process control system of claim 1 further comprising sensors coupled to the system to observe a state (oₜ) and wherein in the control thread, in response to the sensors observing a state (oₜ), the actor component determines an action (aₜ).

5. The process control system of claim 1 further comprising:
means for receiving one or more control inputs; and
means for measuring one or more outputs means for providing a control signal.

6. The process control system of claim 1 wherein the means for updating the critic component comprises means for updating the critic component according to a difference between the Q-value and the target value difference.

7. The process control system of claim 6 wherein the means for updating the critic component comprises updating the critic component by reducing the difference between the Q-value and the target value.

8. The process control system of claim 1 wherein means for updating the actor component according to the critic component's evaluation (Q-value) comprises means for updating the actor updating the actor by maximizing the critic's evaluation (Q-value).

9. A learning method comprising:
(a) providing a model comprising four long short-term memory (LSTM) networks having respective network components actor π_{φ}, critic Q_{θ}, target actor τ′_{φ′} and target critic Q′_{θ′} wherein φ, θ, φ′, θ′ correspond to the parameters of each network;
(b) manipulating the four LSTM networks in three sub-processes with a first one of the sub-processes corresponds to an initialization process, a second one of the sub-processes corresponds to a control thread, and a third one of the sub-processes corresponds to a training thread;
(c) storing observations, actions and rewards in a history memory H;
(d) sampling, in the training thread, data from the history memory;
(e) feeding the sampled data from the history memory into the critic;
(f) computing, in the critic, a Q-value as an output;
(g) comparing the Q-value with a target value computed by target networks;
(h) updating the critic according to a comparison between the Q-value and the target value; and
(i) updating the actor according to the critic's evaluation (Q-value).

10. The learning method of claim 9 wherein:
(b1) the control thread and the train thread run concurrently throughout an entire control process;
(b2) wherein in the control thread, sensors attached to the system observe (oₜ) a state and the actor computes an action (aₜ);
(b3) wherein a reward (rₜ) is computed using a reward function.

11. The learning method of claim 9 wherein updating the critic according to a comparison between the Q-value and the target value corresponds to updating the critic according to a difference between the Q-value and the target value difference.

12. The learning method of claim 11 wherein updating the critic comprises updating the critic by minimizing the difference between the Q-value and the target value.

13. The learning method of claim 9 wherein updating the actor according to the critic's evaluation (Q-value) comprises updating the actor by maximizing the critic's evaluation (Q-value).

14. A fiber drawing system comprising:
a deep reinforcement learning (DRL) based fiber drawing controller for predictively regulating a diameter of a fiber and to track dynamically varying reference trajectories;
one or more fiber drawing towers;
an extruder system configured to heat and feed a preform into the system;
a laser micrometer configured to measure the fiber diameter after fiber is drawn from the extruder;
a cooling system configured to cool the produced fiber; and
a spool system configured to store the produced fiber.

15. The fiber drawing system of claim 14 wherein the fiber drawing towers have a height lower than a height of a conventional fiber drawing tower.

16. The fiber drawing system of claim 14 wherein the DRL-based fiber drawing controller comprises:
four long short-term memory (LSTM) networks, the LSTM networks comprising respective ones of an actor component π , a critic component Q_{θ}, a target actor component π′_{φ′} and a target critic component Q′_{θ′} wherein φ, θ, φ′, θ′ correspond to the parameters of each network;
means for manipulating the four LSTM networks in three sub-processes with a first one of the sub-processes corresponds to an initialization process, a second one of the sub-processes corresponds to a control thread, and a third one of the sub-processes corresponds to a train thread;
means for computing a reward (rₜ) using a reward function;
a history memory H configure to store observations, actions and rewards;
means for sampling data from the history memory;
means for providing the sampled data into a critic and in response thereto the critic computes a Q-value as an output;
means for comparing the Q-value with a target value computed by target networks;
means for updating the critic component according to a comparison between the Q-value and the target value; and
means for updating the actor according to the critic's evaluation (Q-value).

17. The fiber drawing system of claim 16 wherein:
(b1) the control thread and the training thread execute currently throughout an entire control process;
(b2) wherein in the control thread, sensors attached to the system observe (oₜ) a state and the actor computes an action (aₜ);
(b3) wherein a reward (rₜ) is computed using a reward function.

18. The fiber drawing system of claim 17 wherein means for updating the critic component comprises means for updating the critic according to a difference between the Q-value and the target value difference.

19. The fiber drawing system of claim 17 wherein means for updating the actor according to the critic's evaluation (Q-value) comprises means for updating the actor updating the actor by maximizing the critic's evaluation (Q-value).

20. The fiber drawing system of claim 17 further comprising means for receiving one or more control inputs and means for measuring one or more outputs and wherein:
the one or more control inputs correspond to one or more of: a spool voltage; and a preform federate;
the one or more outputs correspond to one or more of: diameter and spool speed; and
based upon the inputs and outputs, the DRL controller regulates a diameter of the fiber.
